(19) United States
(12) Patent Application Publication
(10) Pub. No.: US 2026/0002809 A1
(43) Pub. Date: Jan. 1, 2026

(54) FLUID STORAGE MONITORING

(71) Applicant: ICEYE OY, Espoo (FI)

(72) Inventors: Simon Andersson, London (GB); Tapio Friberg, Solothurn (CH); Michael Wollersheim, Foothills (CA)

(21) Appl. No.: 19/106,847

(22) PCT Filed: Aug. 15, 2023
(86) PCT No.: PCT/EP2023/072485

§ 371 Date: Feb. 26, 2025

(30) Foreign Application Priority Data
Aug. 31, 2022 (GB) 2212690.8

(51) Int. Cl. G01F 23/284; G01S 13/90; G06V 20/13

(52) U.S. Cl. CPC G01F 23/2845; G01S 13/9027; G06V 20/13

(57) ABSTRACT

A method of monitoring the stored volume of a fluid in a storage container having a lid resting on the surface of the fluid stored, the method comprising: receiving a plurality of sets of image data collected by one or more satellites in orbit around the Earth, wherein each set of image data corresponds to a respective synthetic aperture radar image of an area on Earth that includes the storage container; grouping the plurality of sets of image data into one or more groups based on one or both of the direction of travel and/or the look direction of the respective satellite that collected the set of image data; and for each of the one or more groups: geometrically aligning at least two of the sets of image data within the group to define a stack of aligned image data; identifying. in the stack of aligned image data a feature corresponding to a point on the bottom edge of the storage container; geometrically aligning another set of image data from amongst the plurality of sets of image data with the stack of aligned image data; identifying. in the another set of image data, a feature corresponding to a point on the lid; and determining, based on the identified features, an estimate of the height of the lid relative to the bottom edge of the storage container.

### TECHNICAL FIELD

The present application relates to methods and systems for monitoring and/or measuring the amount of fluid stored in a storage container having a lid that rests on the surface of the stored fluid. In particular, the application relates to methods and systems for monitoring and/or measuring the amount of oil stored in oil storage containers using satellite imaging techniques.

### BACKGROUND

In many settings, bulk volumes of fluid are stored in large storage containers with lids that rest on the surface of the stored fluid. In the context of liquid storage, these lids may be floating lids configured to float on top of the surface of the liquid stored in the storage container so as to rise and fall as the stored volume increases and decreases. In the context of gas storage, the container may be lined with an elastic material that can inflate and is configured to inflate and deflate as gas is injected into and withdrawn from the container so that the “lid” part of the liner rises and falls as the stored volume increases and decreases. In each case, as the fluid is drained from a storage container and refilled, the lid moves up and down with the volume of fluid inside. These storage containers may take the form of canisters. In some contexts, for example in the context of floating-lid oil storage canisters, the containers may be cylindrical canisters having a height typically in the range between 10 metres and 60 metres, and having a diameter typically in the range between 10 metres and 200 metres. It is useful to monitor the volume of fluid stored in such containers for the purposes of stock control and also for safety reasons as large quantities of oil can represent a significant fire risk. Furthermore, regular draining and replenishment of an oil storage container could be indicative of a large amount of activity that consumes fuel—for example it could be indicative of a large increase in industrial activity in the vicinity of the containers.

Known methods of monitoring the volume of fluid (e.g., oil) stored in these containers involve measurement of the containers on-site. This requires access to the site which may not always be feasible. Alternative methods involve determining volumes of stored liquids based on images taken by aircraft, for example unmanned aerial vehicles (UAVs), flying over the storage containers. However, these methods rely on access to the airspace in the vicinity of the storage containers which may not be possible, particularly if the containers are stored in the vicinity of major transportation hubs such as ports and airports, where airspace access may be restricted.

The inventors have devised methods of monitoring stored fluid volumes in light of the above considerations.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter; variants and alternative features which facilitate the working and/or serve to achieve a substantially similar technical effect should be considered as falling into the scope of the claims.

In a general sense, the present disclosure provides methods and systems for monitoring changes in the volume of fluid stored in containers with lids that rest on the surface of the stored fluid, in particular the methods disclosed herein provide a means by which changes in the volume of fluid stored in such a container can be detected even if the change is on a scale that is smaller than the resolution of the images upon which the analysis is based. The invention is defined as set out in the appended set of claims.

In a first aspect, there is provided a method of monitoring the stored volume of a fluid in a storage container having a lid resting on the surface of the fluid, the method comprising: receiving a plurality of sets of image data collected by one or more satellites in orbit around the Earth, wherein each set of image data corresponds to a respective synthetic aperture radar image of an area that includes the storage container; grouping the plurality of sets of image data into one or more groups based on one or both of the direction of travel and/or the look direction of the respective satellite that collected the set of image data; and for each of the one or more groups: geometrically aligning at least two of the sets of image data within the group to define a stack of aligned image data; identifying, in the stack of aligned image data, a feature corresponding to a point on the bottom edge of the storage container; geometrically aligning another set of image data from amongst the plurality of sets of image data with the stack of aligned image data; identifying, in the another set of image data, a feature corresponding to a point on the lid; and determining, based on the identified features, an estimate of the height of the lid relative to the bottom edge of the storage container.

The process of geometrically aligning and combining the images may also be referred to herein as “co-registering” the images. Geometrically aligning the images may be understood as being the process of aligning images such that features within the images that are clearly features corresponding to the same imaged objects (e.g., because of their geometry) are overlaid upon one another. The process of co-registering images may reduce noise in the eventually generated two-dimensional image that is obtained by combined all of the aligned images.

However, when collecting satellite-SAR images, the qualitative nature of the images is strongly dependent upon both the direction of orbit of the satellite and on the direction (relative to that orbital direction) that the satellite is looking. The inventors have determined that grouping satellite-SAR image data based on the direction of travel of the satellite and/or the look direction of the satellite that collects each set of image data, and then co-registering image data only within each group results in more accurate noise reduction and facilitates a more reliable identification of the features corresponding to the point on the bottom edge and the point on the lid.

In some embodiments, the method may further comprise: combining the determined estimates for multiple groups to obtain an overall determination of the height of the lid relative to the bottom edge of the storage container during the first period of time. In this way, any errors in the determination that are based upon the groupings of the sets of image data may be accounted for to yield an overall more reliable determination of the height of the lid.

In some embodiments, the method may further comprise: receiving a further set of image data collected by a satellite in orbit around the Earth at a second time outside the first time period, wherein the further set of image data corresponds to a synthetic aperture radar image of an area that includes the storage container; and applying interferometric analysis between a set of image data from the plurality of sets of image data and the further set of image data to determine if the height of the lid relative to the bottom edge of the storage container has changed between the first time period and the second time.

By applying interferometric analysis, it can be determined whether the height of the lid relative to the bottom of the storage container has changed. That change may be smaller than the resolution of the synthetic aperture radar image(s) collected by the satellite(s).

In some embodiments, the method may further comprise: if it is determined that the height of the lid has changed between the first time and the second time: identifying, in a two-dimensional image generated based on the received further set of image data, features corresponding to each of: each of a point on the bottom edge of the storage container, and a point on the lid; and determining, based on the identified features, the height of the floating lid relative to the bottom edge of the storage container at the second time.

In some embodiments, the method may further comprise: if it is determined that the height of the lid has changed between the first time period and the second time: receiving a plurality of further sets of image data collected by one or more satellites in orbit around the Earth within a second time period, said second time period including the second time, wherein each further set of image data corresponds to a respective synthetic aperture radar image of an area on Earth that includes the storage container; grouping the plurality of further sets of image data into one or more groups based on one or both of the direction of travel and/or the look angle of the respective satellite that collected each set of image data; and for each of the one or more groups: geometrically aligning at least two of the sets of image data within the group; combining the aligned image data to obtain a two-dimensional image; identifying, in the two-dimensional image, features corresponding to each of: a point on the bottom edge of the storage container, and a point on the lid; and determining, based on the identified features, an estimate of the height of the lid relative to the bottom edge of the storage container during the second period of time.

In some embodiments, the method may further comprise: combining the determined estimates of the height of the lid during the second period of time for each of the groups to obtain an overall determination of the height of the lid relative to the bottom edge of the storage container during the second period of time.

In this way, the methods disclosed herein may enable quantitative determination of the extent to which the stored volume of fluid has changed between the first time and the second time.

In some embodiments, grouping the plurality of sets of image data may comprise: assigning each of the plurality of images into a group wherein sets of image data collected by a satellite travelling in an ascending orbit are assigned to a different group to sets of image data collected by a satellite travelling in a descending orbit.

In some embodiments, grouping the plurality of sets of image data may comprise: assigning each of the plurality of images into a group wherein sets of image data collected by a satellite with a look angle oriented to the left of the direction of orbit of the satellite are assigned to a different group to sets of image data collected by a satellite with a look angle oriented to the right of the direction of orbit of the satellite.

As discussed above, the qualitative nature of satellite-SAR images is strongly dependent upon both the direction of orbit of the satellite and on the direction (relative to that orbital direction) that the satellite is looking. A suitable grouping may be achieved by grouping sets of image data according to whether the satellite that collected the set is in an ascending or descending orbit. An ascending orbit is one in which the satellite is orbiting in a generally south-to-north direction, while a descending orbit is one in which the satellite is orbiting in a generally north-to-south direction.

Additionally, an alternative suitable grouping may be achieved by grouping sets of image data according to whether the satellite that collected the set is looking leftward or rightward relative to the direction of travel of said satellite.

In some examples, a combination of these groupings may be implemented. For example, there may be four groups: (i) left-looking ascending orbit, (ii) left-looking descending orbit, (iii) right-looking ascending orbit, and (iv) right-looking descending orbit. These four geometries may be considered to represent four qualitatively distinct geometries in the context of satellite-SAR imagery and have been found by the inventors to achieve the benefits of improved reliability in the feature identification and height determination of container lids, whilst not overburdening computing resources by maintaining an excessive number of grouping options.

In some examples, some sets of image data may be discarded if they are considered to be outliers. For example, it may be preferable for the look angle of the satellite that collects each set of image data to be within a predetermined range. This range, for example, be between 5 and 45 degrees, 5 and 40 degrees, 5 and 30 degrees, 5 and 20 degrees, 5 and 15 degrees, 5 and 10 degrees, 10 and 40 degrees, 10 and 30 degrees, 10 and 20 degrees, 10 and 15 degrees, 15 and 40 degrees, 15 and 30 degrees, 15 and 20 degrees, 20 and 40 degrees, 20 and 30 degrees, and 30 and 40 degrees. In one particular example the range may be between 15 and 30 degrees.

Grouping satellite-SAR image data based on the direction of travel of the satellite and/or the look direction of the satellite that collects each set of image data, and then co-registering image data only within each group results in more accurate noise reduction and facilitates a more reliable identification of the features corresponding to the point on the bottom edge and the point on the lid.

In some embodiments, determining the height of the lid relative to the bottom edge of the storage container may comprise: determining the distance between the feature corresponding to the bottom edge of the storage container and the feature corresponding to the lid in the two-dimensional image; determining a height of the lid based on the determined distance and a look angle from which the satellite collects the corresponding image data.

In this way, it is possible to determine the height of the lid without having to calibrate the first image data against a reference image. This is achievable because it is possible to use the height and/or diameter of the storage container to self-calibrate the image data.

In some embodiments, the determined height of the lid may be determined with a resolution of 2.5 m or better, 1 m or better, 0.5 m or better, 10 cm or better, or 1 cm or better.

In some embodiments, each of the identified features may comprise one or more pixels in the image having a stronger signal than each of the pixels surrounding the one or more pixels.

In some embodiments, each of the identified features may comprise only a single pixel.

The features corresponding to each of the point on the bottom edge of the lid and the point on the lid may be two of the brightest pixels in the respective SAR image or the two brightest pixels. This is because, in the context of SAR imaging, each of these features may be detected by collecting a radar signal that has undergone a so-called ‘corner reflection’. Corner reflections in SAR imagery occur when there are two perpendicular, or substantially perpendicular, reflecting surfaces (e.g. the ground and the bottom of the external wall of the container, or the lid and an internal wall of the container). Such reflections may give rise to particularly strong signals in the corresponding SAR image data.

In some embodiments, applying the interferometric analysis to determine if the height of the lid relative to the bottom edge of the storage container has changed between the first and second time may comprise: determining the amount of change in the height of the lid based on the interferometric analysis.

In some examples, the resolution of the determined amount of change in the height of the lid may be between 20 centimetres and 1 metre. In other words, InSAR can be used to quantify the change in the height of the lid with a high resolution, for example on the order of 20 centimetres to 1 metres.

By determining the height change based on interferometric analysis, it may be possible to quantitatively determine the amount of change in the height of the lid with a resolution that exceeds that obtainable by simply analysing a single SAR image.

In some embodiments, applying the interferometric analysis may be applying differential interferometric analysis to determine the amount of change in the height of the lid.

In some examples, the resolution achieved by applying differential interferometric analysis may be between 1 and 10 centimetres. In other words, differential InSAR can be used to quantify the change in the height of the lid with an even higher resolution, for example 10 centimetres or better.

By applying differential interferometry, the resolution of the determined amount of change may be improved by a factor of two to twenty or more relative to standard (i.e., non-differential) interferometric analysis.

In some embodiments, the method may further comprise: identifying, in the each of the plurality of sets of image data, one or more storage containers in the respective area; and performing the identifying of the features and determining of the height of the corresponding floating lid for each of the identified storage containers.

In some embodiments, applying the interferometric analysis comprises identifying for which of the one or more storage containers the height of the floating lid changed between the first time period and the second time.

In this way, the methods disclosed herein may be extended to be applied to multiple storage containers simultaneously. In particular, by applying interferometric analysis, the computational burden of detecting changes in the amount of stored volume is significantly reduced. This is, in part, because instead of having to quantitatively measure each storage container, the interferometric analysis efficiently and simultaneously identifies which of the storage containers have changed in the amount of fluid stored therein.

In another aspect, there is provided a method of monitoring the stored volume of a fluid in a storage container having a lid resting on the surface of the fluid stored, the method comprising: receiving a first set of image data collected by a satellite in orbit around the Earth at a first time, wherein the first set of image data corresponds to a synthetic aperture radar image of an area on Earth that includes the storage container; identifying, in a two-dimensional image corresponding to the first set of image data, features corresponding to each of: a point on the bottom edge of the storage container, and a point on the lid; determining, based on the identified features, an estimate of the height of the lid relative to the bottom edge of the storage container at the first time; receiving a second set of image data collected by a satellite in orbit around the Earth at a second time, wherein the second set of image data corresponds to a synthetic aperture radar image of an area that includes the storage container; and applying interferometric analysis between the first set of image data and the second set of image data to determine if the height of the lid relative to the bottom edge of the storage container has changed between the first time and the second time.

In another aspect, there is provided a computer comprising a processor configured to cause the computer to carry out the methods disclosed herein.

In another aspect, there is provided a computer readable medium comprising instructions that when executed by a computer cause the computer to carry out the methods disclosed herein.

In another aspect, there is provided a computer program comprising logic that when executed by a computer causes the computer to carry out the methods disclosed herein.

The methods described herein may be performed by software in machine readable form on a tangible storage medium e.g., in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is issued for designing silicon chips, or for configuring universal programmable chips, to carry out desired functions.

The features and embodiments discussed above may be combined as appropriate, as would be apparent to a person skilled in the art, and may be combined with any of the aspects except where it is expressly provided that such a combination is not possible or the person skilled in the art would understand that such a combination is self-evidently not possible.

### BRIEF DESCRIPTION OF THE DRAWINGS

Embodiments of the claimed subject matter are described below, by way of example, with reference to the following drawings.

FIG. 1 depicts an exemplary satellite in orbit around the Earth.

FIG. 2 shows a method for monitoring the volume of fluid stored in one or more storage containers.

FIG. 3 shows an exemplary satellite imaging an exemplary storage container.

FIG. 4 shows a comparison of the determined volume of oil stored within an oil storage container compared to an alternative method known to yield ‘true’ results.

FIG. 5 shows a method of monitoring changes in the height of a lid of a storage container.

FIG. 6a shows an example oil storage tank being monitored over a three-day period with only an imperceptible change in the position of the floating lid.

FIG. 6b shows an example of an oil storage tank being monitored over a subsequent two-day period showing a significant draw-down in oil volume.

FIG. 7 shows a schematic of a computer comprising a processor configured to implement the methods described herein.

Common reference numerals are used throughout the figures to indicate the same or similar features.

### DETAILED DESCRIPTION

Embodiments of the present claimed subject matter are described below by way of example only. These examples represent the best mode of putting the claimed subject matter into practice that are currently known to the Applicant although they are not the only ways in which this could be achieved. The description sets forth the functions of the example and the sequence of steps for constructing and operating the example. However, the same or equivalent functions and sequences may be accomplished by different examples.

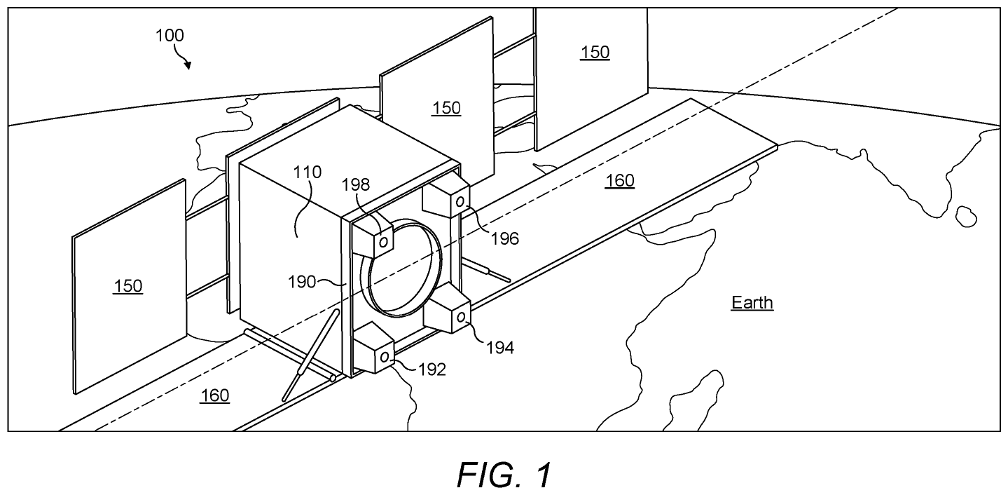

FIG. 1 depicts an exemplary satellite 100 in orbit around the Earth of the kind which may be used in the implementation of the systems and methods described here. The satellite of FIG. 1 comprises a body 110 which may be referred to in the art as a “bus” since it may house or support so-called bus components of a satellite. Body 110 may additionally house one or more batteries. Body 110 may be partially enclosed, for example to house and protect components. A housing may provide surfaces on which components may be mounted. In the example of FIG. 1, a solar panel 150 is mounted on one rectangular surface of the body 110 and additional solar panels may be attached to panel 150 by struts.

The example satellite 100 shown in the figures comprises a radar antenna array 160 in the form of a generally planar structure extending from the bus 110 in two opposing directions to provide two “wings”. The structure comprising wings 160 is shown to be mounted on or adjacent to a rectangular surface of the body 110. The body 110 and wings 160 of the satellite 100 may be collected referred to as the spacecraft frame. The antenna array 160 together with associated amplifiers and power distribution system, not shown, collectively form image acquisition apparatus of the satellite.

In a synthetic aperture radar system, or SAR system the antenna array 160 is operated to transmit radar signals to the Earth and listen for the returning echoes. By recording the echoes, an image of the Earth's surface can be constructed from data including the length of time taken for the echo to return (indicating location), the amplitude of the radar return, and the phase information that is included within the radar signal. Further location information is obtained from the frequency of the returned signal which is shifted due to the Doppler effect as a result of the relative motion of the satellite to the earth.

The satellite 100 is provided with a propulsion system 190 for manoeuvring the satellite with a generated thrust. The propulsion system 190 comprises a plurality of thrusters 192, 194, 196, 198 that produce thrust for manoeuvring the satellite 100 when required, for example to position the satellite onto a different orbital track. The plurality of thrusters 192, 194, 196, 198 shown in FIG. 1 are positioned at the corners of one side of the body 110 and may be equally spaced apart. However, in some embodiments, the propulsion system 190 may have a different configuration.

In some examples, the satellite may be a micro-satellite or a small satellite. The smaller size and greater agility of micro and small satellites may provide advantages for fluid storage monitoring, and in particular for oil storage monitoring. Specifically, micro- and small satellites are more agile, and their orientation and orbital paths can be changed more easily in response to instructions to image a particular location on Earth and from a particular angle. In addition, smaller satellites can be significantly less expensive to manufacture and launch than traditional larger satellites. More of them can be launched for the same cost as a single larger satellite in order to form a constellation of satellites that can provide much more frequent revisit times compared to a single satellite, as described above. In some examples, the satellites can be deployed in constellation of five satellites or more, ten satellites or more, or twenty satellites or more.

In an example, satellite 100 may be a micro-satellite with a mass of approximately 100 kilograms. Traditional larger satellites may have a mass of approximately 1000 kilograms and are generally more expensive and less agile than micro- or small satellites. Satellites may, in some examples, be categorised according to their mass. For example, a satellite having a mass between approximately 1 kilogram and approximately 10 kilograms may be categorised as a cube satellite; a satellite having a mass between approximately 50 kilograms and approximately 250 kilograms may be categorised as a micro-satellite; and satellite having a mass of approximately 500 kilograms may be categorised as a small satellite; and a satellite having a mass between approximately 800 kilograms and approximately 1200 kilograms may be categorised as a regular satellite.

In an example, the satellite 100 may be orbiting Earth in a low-earth orbit. A low-earth orbit may have an altitude between 160 kilometres and 1000 kilometres above the surface of the Earth. Examples of Earth-observation satellites based on SAR accordingly can have orbits with an altitude of between 450 kilometres and 650 kilometres above the Earth. In an example of satellites that would be suitable for implementing the methods described herein, a SAR satellite may have an orbit that is approximately 550 kilometres above the Earth's surface. At an orbit of 550 kilometres above the Earth, for example, the satellite may be effectively traversing the ground at approximately 7.5 kilometres per second, or 27,000 kilometres per hour. Most satellites in such an orbit will traverse the Earth at a speed that is in the range of 7-8 kilometres per second.

Whereas some traditional applications of SAR imagery may include applications such as mapping of large areas and developing digital elevation maps of terrain on a larger scale (for example, of mountains), detecting and monitoring fluid storage containers, especially smaller ones, requires higher resolution. In an example, the SAR Earth-monitoring satellite 100 may be able to image with a resolution of 15 metres or less, 10 metres or less, or 3 metres or less. Even high resolutions (e.g., 50 centimetre resolution) can serve to enhance the accuracy of the monitoring. Using the methods described herein, changes in volume of the fluid storage containers that result in lid movements much smaller than even the resolution of SAR imaging techniques may be detectable and quantifiable.

The use of satellite data has additional advantages over conventional terrestrial-based imaging approaches. For example, monitoring fluid storage containers from space has significant advantages in terms of being able to obtain images of the fluid container(s). In some contexts and scenarios, the storage container(s) may be in a remote and/or restricted area such that it is not feasible to obtain images of the storage container(s) from a terrestrial imaging device. The use of satellite data also facilitates global coverage of the methods disclosed herein, and may improve the frequency with which images of the dry-bulk stockpile can be collected.

Further, the use of satellite synthetic aperture radar (SAR) data has advantages over approaches that use aerial photography. In particular, monitoring using aerial photography requires the use of dedicated aircraft and may be severely impacted by adverse weather conditions, particularly cloud cover. In contrast, satellite radar imaging can pierce cloud cover to obtain images of the storage container(s).

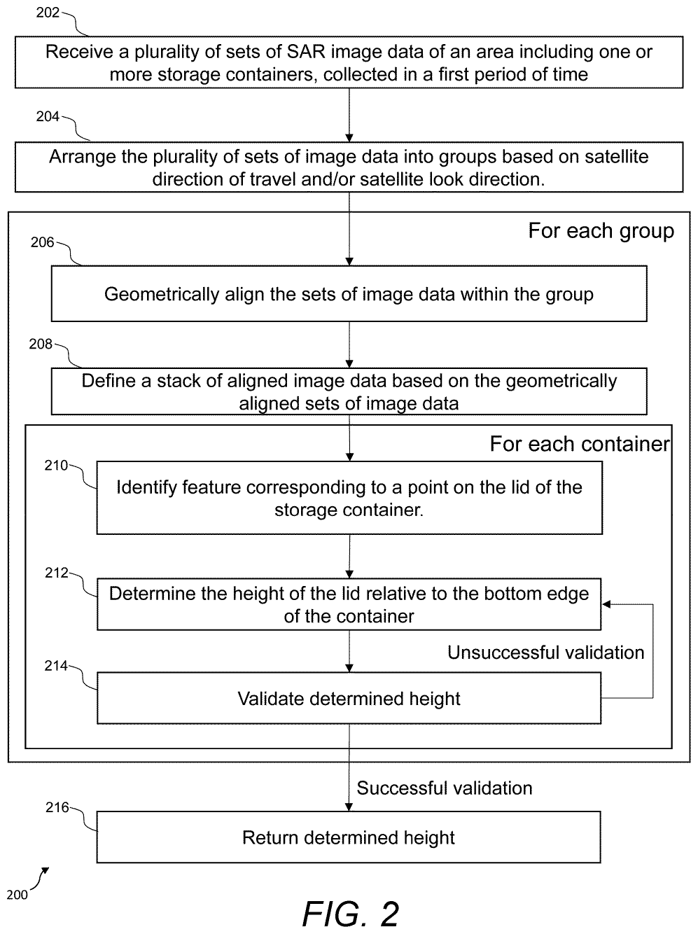

FIG. 2 shows a method 200 for monitoring the volume of fluid stored in one or more storage containers. The storage containers may be any containers suitable for storing fluids, the containers having respective lids that rest on the surface of the fluid stored within the container. The fluid could be liquid or gas. For example, the storage containers could be configured to store gas (e.g., natural gas), and the lids could be made from an elastic material, the lid being part of a container liner configured to inflate and deflate as the quantity of gas in the container is increased and decreased. In other examples, the storage containers may be liquid storage containers, and in particular examples, may be oil storage containers. In such containers, the lids may be floating lids that rise and fall as the level of liquid (e.g., oil) within the container is increased and decreased.

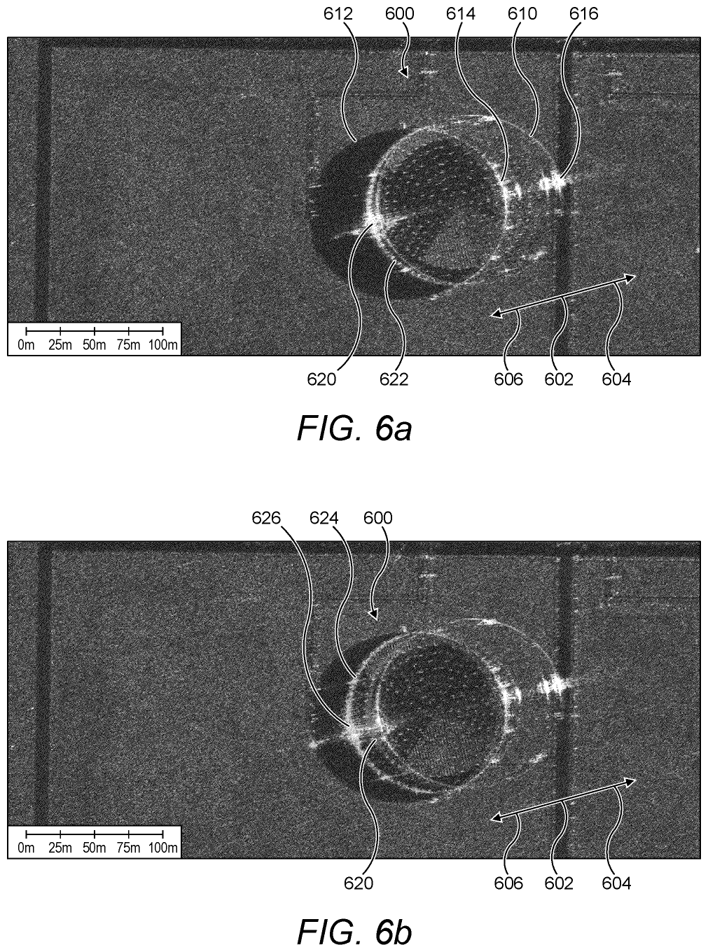

The method of FIG. 2 may be implemented in a computing system, further details of which are described with reference to FIG. 6. Thus, some or all of the operations described with reference to FIG. 2 may be automated. Some may be performed by a human operator.

In a first operation 202, a plurality of sets of SAR image data are received, each of a respective area that includes one or more storage containers. The plurality of sets of SAR image data was collected by one or more satellites within a predetermined first period of time. Each set of image data was collected by a single satellite. For example, each of the sets of SAR image data may have been collected by a respective satellite in a single pass of the satellite over the area. Alternatively, each of the sets of SAR image data may have been collected within a predetermined time window. The duration of this time window may be short enough that each of the sets of SAR image data can be considered to have been collected substantially simultaneously, or within a short enough time period that the volume of fluid stored in each of the one or more containers can be considered to have not changed.

In some examples, this time window may be within three hours or less. According to an example, a typical orbit time for an Earth-monitoring satellite in low-Earth is approximately 90 minutes. If the orbit of the satellite is configured to pass over the same area in a subsequent orbit it the time period could be 90 minutes. In other examples, the time period could be six hours or less, 12 hours or less, 24 hours or less, or 48 hours or less. The time period could also be over a longer duration of up to several weeks or months, for example. During the longer time period the amount of fluid stored in each of the one or more containers is more likely to have changed, so shorter time periods are preferred. However, when collecting imagery for an initial reference composite (or reference stack) it can be over a longer period of time because the aim of a reference composite/stack is to accurately locate the base (i.e., the bottom edge of the storage container). The base location generally will not change unless new tanks are built or old ones are decommissioned.

In some embodiments, a further operation 204 comprises arranging the sets of image data into groups based on, for example, one or both of the satellite direction of travel and the satellite look direction. For example, as discussed above, operation 204 may comprise arranging the plurality of sets of SAR image data into up to four different groups based on both the look direction of the satellite and on the orbit direction of the satellite. The four groups may comprise but are not limited to (i) left-looking ascending orbit, (ii) left-looking descending orbit, (iii) right-looking ascending orbit, and (iv) right-looking descending orbit. In some examples, some of the sets of SAR image data may be discarded if the look angle of the satellite that collected said set does not fall within a predetermined range. For example, in an example, only sets of SAR image data that have been collected by a satellite having a look angle between 15 and 30 degrees may be arranged into one of the groups.

A further operation 206 comprises, for each group, geometrically aligning the SAR image data within said group. A further operation 208 comprises, for each group, defining a stack of aligned image data based on the geometrically aligned images. This stack of aligned image data may be used to generate a reference composite image that may be used to identify the location of the bottom edge of the storage container. This alignment process may also be referred to as co-registration. Geometrically aligning the images may be understood as being the process of aligning images or image data such that features within the images that correspond to the same imaged objects (e.g., because of their geometry) are overlaid upon one another. The process of co-registering images or image data may reduce noise in the eventually generated two-dimensional image that is obtained by combining all of the aligned images. Co-registration with the reference composite/stack also allows for locating the base in the new image in case the base is not visible in the new image. Typically, previous co-registration algorithms have required acquisitions with very similar angles.

In some examples, the method further comprises identifying, in the generated two-dimensional SAR image one or more storage containers (this operation is not shown in FIG. 2). Identifying the one or more storage containers in the image may involve implementing appropriate image recognition algorithms to identify shapes in the two-dimensional SAR image. For example, in the context of cylindrical storage canisters, identifying the one or more storage containers in the image may involve implementing an appropriate image recognition algorithm to identify circular features in the two-dimensional SAR image. Such an image recognition algorithm may, for example, be a known machine learning algorithm configured to detect predetermined shapes in one or more images. The machine learning algorithm may, for example, include deep learning operations, convolutional neural network structures, and/or semantic segmentation operations. Alternatively, identifying each of the one or more containers may be done manually by a user of the method.

In another example, tanks can be identified first by using optical satellite imagery-either manually or with machine learning, then the tank coordinates can be passed to the SAR image using reverse geocoding. This method may have benefits because in practice tanks may be more easily recognised in optical imagery, and optical sensors such as Sentinel-2 have global coverage.

A further operation 210 comprises, for each of the identified storage containers, identifying a feature in the generated two-dimensional SAR image that will be used in operation 212 to determine how full the fluid storage tank is. In an example, operation 210 can include identifying features that corresponds to a point on the lid of the container. It may optionally include acquiring a point on the bottom edge of the storage container. In another example, the location of the base is already determined using the reference composite/stack and may only require small manual adjustments. These features may be representative of, for example, the point on the bottom edge of the container closest to the satellite in the range direction, and the point on the lid furthest away from the satellite in the range direction. In the context of satellite-SAR imaging, the range direction may be understood as being the direction along a line of sight from the satellite to the imaging area, perpendicular to the direction of the satellite.

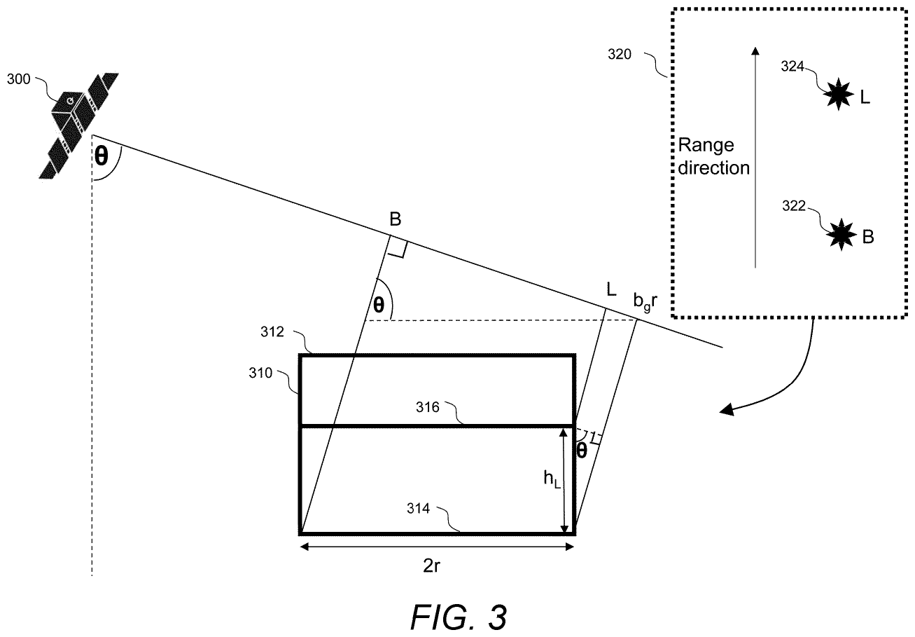

FIG. 3 shows an example of how the volume of fluid within a fluid storage container may be calculated. The features may be identified as, for each storage container, a pair of bright points (e.g., the two brightest pixels) 322, 324 in a search window 320. The search window 320 may correspond to an area in which the storage container is identified as being located. For example, the bright pixel 322 may be representative of the nearest point (in the range direction) of the bottom edge 314 of the storage container 310, while the bright pixel 324 may be representative of the furthest point (in the range direction) of the lid 316. As can be seen from FIG. 3, these bright points arise because SAR imaging signal is returned to the satellite 300 from the nearest point of the bottom edge 314 of the storage container 310 and from the lid 316 due to corner reflections from the external and internal walls of the container 310 respectively. This phenomenon is also known as “double bounce” scattering, and the extra reflections contribute to the brightness of the radar return from this feature. In another example, only the bright pixel 324 representing the further point (in the range direction) of the lid 316 is identified within the search window in case the location of the bottom edge 314 of the storage 310 is already known from the reference composite image/reference stack.

A further operation 212 comprises, for each identified storage container, determining the height of the lid relative to the bottom of the container. An example method for determining the height of the lid relative to the bottom of the container may be understood with reference to FIG. 3.

In the context of FIG. 3, a satellite 300 is imaging a storage container 310 with a look angle of θ. The look angle, θ, may be understood as being the angle between the line of sight of the satellite 300 to the storage container 310 and the line from the satellite 300 to its nadir, which is the point on the ground directly below the satellite. In such a system, when forming an SAR image, the two-dimensional image of the storage container 310 will take the form of two ‘bright-pixel’ features 322, 324 within a search window 320. As discussed above, the bright pixel 322 may be representative of the nearest point (in the range direction) of the bottom edge 314 of the storage container 310, while the bright pixel 324 may be representative of the furthest point (in the range direction) of the lid 316.

As discussed above, in the context of SAR imaging, the direction observed along the direction of the satellite's 300 line of sight is referred to as the range direction, and a two-dimensional SAR image generated from collected SAR data will have distances between points in the image determined in the range direction of the satellite 300. The search window 320 is part of the two-dimensional SAR image. The SAR satellite 300 works by sending a radar signal to the ground and listening for the returning radar echoes. The distance from the satellite to a particular object on Earth can be determined from the amount of time it takes for the radar signal to travel to the object and to be received back at the satellite. The location of the object on the ground can then be calculated and a SAR image formed from all of the returning radar echoes. However, this means that the radar return from a structure (such as a storage container) that has a height extending above ground level will appear in a SAR image to be closer in the range direction to the satellite than it actually is. In effect the top of a structure will be shown in the SAR image as being laterally displaced from the bottom of the structure in the range direction, instead of being vertically displaced—in other words, structures appear flattened in SAR images. This is because the distance from the satellite to the top of an object is slightly less than the distance from the satellite to the bottom of the object. As such, the top of a tall object will appear in the SAR image to be closer to the satellite than its base. This phenomenon is often referred to as the ‘layover’ of an SAR image. This phenomenon can be exploited to help determine the heights of objects. By taking advantage of the particular geometry of fluid storage tanks with floating lids it can also be used to determine the heights of the lids, as will be described further below.

With reference again to FIG. 3, it is possible to determine the position of furthest point, b_{g}r, (in the range direction) of the bottom edge 314 of the storage container 310, even though it is in the radar “shadow” of the tank and cannot be directly imaged by the satellite in this geometry. However, the position of the furthest point can still be determined based solely on the identified feature 322 corresponding to point B (the closest point of the bottom edge 314 of the storage container), the look angle, θ, of the satellite, and the diameter, 2r, of the storage container. The diameter of the storage container 310 may either be measured directly based on the SAR image data, or it may be obtained via appropriate metadata concerning the storage container 310. Alternatively, it can also be obtained from optical data, either from a satellite or from aerial photography. Similarly, the height of the top edge 312 of the storage container 210 may either be measured directly based on the SAR image data or obtained via appropriate metadata concerning the storage container 310.

In this way, the point b_{g}r may be determined by the following equation:

$${b}_{g} r = B + 2 r sin θ$$

which may be readily derived from the geometrical construction of FIG. 3.

Consequently, it is possible to determine the height of the lid 316 relative to the bottom of the container, by determining the distance between the points L and b_{g}r in the range direction, noting that this distance is related to the height, h_{L}, of the lid 316 relative to the bottom 314 of the storage container 210 and to the look angle, ϑ, by the following equation:

$${h}_{L} = \frac{{b}_{g} r - L}{cos θ}$$

which may be readily derived from the geometrical construction of FIG. 3. Note that B, L, and b_{g}r in this expression are all pixel coordinates, and as such h_{L} is also expressed as a number of pixels. It can be converted to metres or other units by multiplying by the pixel spacing pₛr, which is the pixel spacing in metres.

This approach may be referred to as determining the height of the lid 316 based on the layover of the features 322, 324 in the generated SAR image. Note that other methods of using layover to determine the height of the lid could also be used as will be apparent to one skilled in the art, for example by identifying an arc to determine the height of the floating roof of the tank instead of just a single point.

A further operation 214 comprises validating the determined height. Validation is to ensure that the points on the ground and the floating roof are in the right place, i.e., that the points have been detected correctly. Sometimes, especially with smaller tanks, the floating roof as well as the base can be hard to detect, thus requiring additional validation steps. In another example, the base may be in the wrong location due to misregistration, particularly when the angle differences are high between acquisitions. In an example, validating the determined height may take the form of determining whether or not the determined height is physically plausible. For example, if it is determined that the height of the lid 316 is greater than the height of the top edge 312 of the storage container 310, this may indicate that operation 212 failed to determine the true height of the lid 316. In such instances, the validation of operation 214 is considered to be unsuccessful and the method returns to operation 212 to re-determine the height of the lid. In order to improve the accuracy of the redetermination, the method may further comprise discarding one or more of the features upon which the height determination was based. In other words, operation 212 may be repeated with the determination of the height of the lid 316 being based on one or more different features compared to the original, unsuccessful, determination.

If, however, the determined height is successfully validated (e.g., the determined height is physically plausible and/or within the user's expectations), then the determined height of the lid may be returned to the user in operation 216. After operation 216, the monitoring of the storage container can continue for one or more additional time periods by taking additional SAR images, geometrically aligning them with the stack of aligned image data defined in step 208 to generate a further (i.e., a second) stack of aligned image data, and repeating steps 210 to 216. The results of these subsequent images can show the change in the amount of fluid stored in the storage container over time.

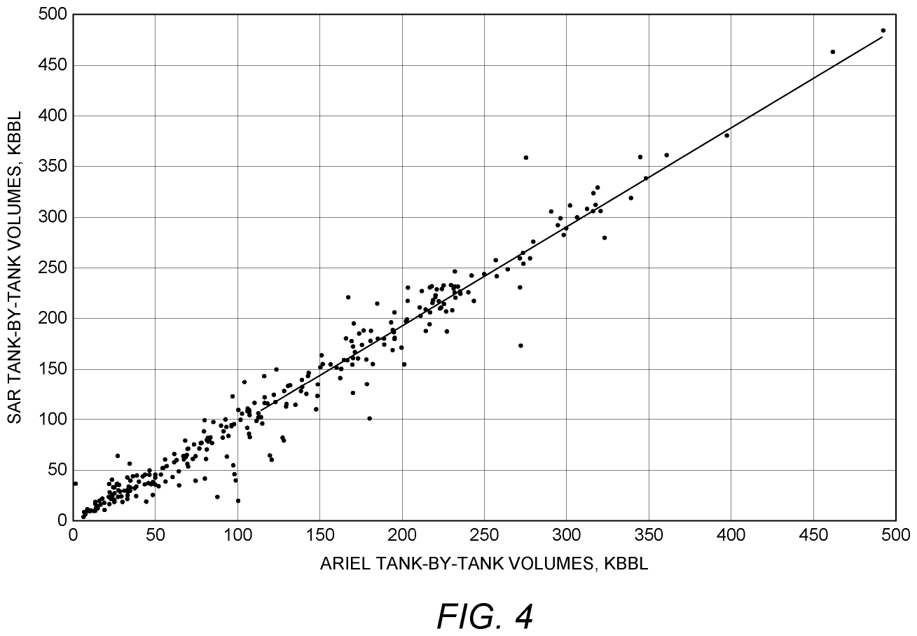

FIG. 4 shows a comparison of the determined volume of oil stored within an oil storage container compared to an alternative method known to yield ‘true’ results shown by the straight line. The volume of oil stored within the container is calculated by determining the height of a floating lid of the container in accordance with the method discussed above in relation to FIG. 2 and multiplying this height by the known cross-sectional area of the storage container. The result is then plotted on the y-axis labelled “SAR tank-by-tank volumes, KBBL”. KBBL is a unit of measurement that refers to 1000 barrels of oil. The x-axis represents aerial surveys of the same tanks from similar time periods. Volumes obtained from this method are plotted on the x-axis. As can be seen from FIG. 4, the method disclosed herein yields reasonably consistent results, especially considering that the satellite images and the aerial surveys are not necessarily taken at exactly the same time.

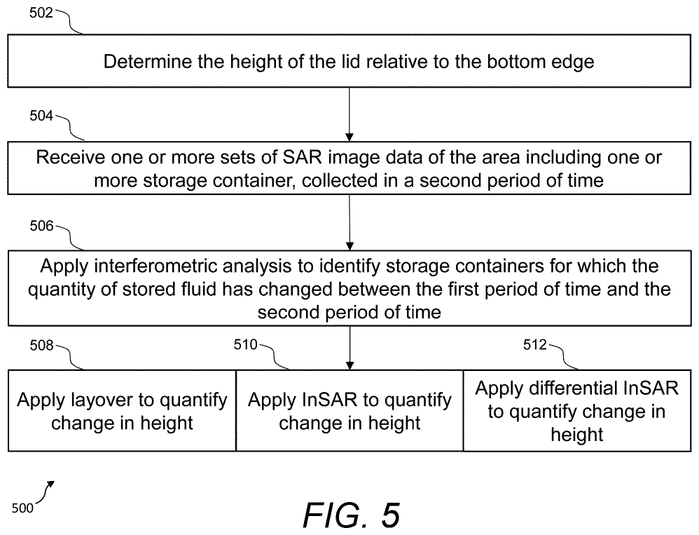

FIG. 5 shows a method of monitoring changes in the height of a lid of a storage container. This may also be performed in a computing system, or some operations may be performed by a human operator.

A first operation 502 comprises determining the height of the lid relative to the bottom edge of the storage container. This is done by carrying out the method set out above in relation to FIGS. 2 and 3. Alternative methods using layover or other techniques known in the art could also be used to determine the height of the lid relative to the bottom edge.

In a further operation 504, one or more sets of SAR image data are received of the area that includes the one or more storage containers 310 collected during a second period of time. Preferably, the second period of time does not overlap with the first period of time. For example, each of the sets of SAR image data may have been collected by a respective satellite simultaneously. Alternatively, each of the sets of SAR images data may have been collected within a predetermined time window. The duration of this time window may be short enough that each of the sets of SAR image data can be considered to have been collected substantially simultaneously, or within short enough a time period that the volume of fluid stored in each of the one or more containers can be considered to have not changed.

In some examples, this time window may be three hours or less, six hours or less, 12 hours or less, or 24 hours or less. The shorter the time window the better the chance that the container has not changed. However, even longer time windows are possible because some storage tanks will change more quickly, while others may stay static for longer periods of time, e.g., on the order of weeks or months.

In some examples, the time separating the first and second period of time may be six hours or less, 12 hours or less, 24 hours or less or 48 hours or less. It could also be longer, for example multiple days, weeks or even months, depending on how quickly the volume of the storage containers is changing and the desired monitoring frequency. This separation may be defined as the time between the end of the first period of time and the beginning of the second period of time, or as the time between the middle of the first period of time and the middle of the second period of time.

In some examples, each of the SAR images corresponding to the one or more sets of SAR image data collected during the second period of time may be geometrically aligned and combined in the same way as is discussed above in relation to operation 304 to generate a second SAR image of the one or more containers.

A further operation 506 comprises applying interferometric analysis to identify storage containers amongst the one or more storage containers for which the quantity of stored fluid has changed between the first period of time and the second period of time. This interferometric analysis may use so-called InSAR techniques. SAR signals include both an amplitude component as well as a phase component. Techniques such as the layover technique described with reference to FIGS. 2 and 3 only require the use of the amplitude component of the data, whereas inSAR uses the phase information in the SAR signal. Because the phase data relates to the frequency of the radar signal being used, changes in phase can be exploited to detect even small changes between the first and second images of the one or more storage containers 310. Changes can be detected that may not be otherwise detectable with other methods, e.g., with the layover technique.

An advantage of using inSAR for change detection is that Operation 506 can be carried out quite quickly by comparing phase values to detect changes in the volume of the storage containers. For example, using just the layover method on its own would require calculating the tank lid height for every single storage container in an image at every satellite pass, to determine whether the tank lid height has changed or not and by how much. With many storage containers and frequent revisits, this could be computationally extensive or even prohibitive, especially if it includes a validation step with manual intervention. Using inSAR can quickly and relatively easily identify just the storage containers that have experienced a change, or identify tanks that have changed by more than a certain threshold. Layover techniques can then be applied to just those containers rather than all of the containers in an image, thereby saving time and computational effort.

The increased sensitivity of inSAR for change detection can also provide additional valuable information regarding the storage container. For example, if a given storage container was drained, or partially drained of fluid and then re-filled to almost exactly the same level between the first and second period of time, the very slight difference in height might not be detectable using layover or other techniques, leading for example, to the erroneous conclusion that the tank has not changed at all. It is even possible that a tank could be drained and refilled to the same height on purpose to mask activity. However, the slight change could still be detectable using InSAR because of InSAR's ability to detect very small changes. As such, the application of interferometric analysis may mean that it can be determined whether the height of the lid 316 has changed, even if that change is smaller than the resolution of the SAR image(s) collected by the satellite(s). Even though it may not have been possible to detect exactly how much fluid was drawn down and then refilled from the storage tank, inSAR can help to highlight that there was activity at that particular storage container and could also be used for example to determine a level of confidence in the calculations of fluid input and output from that tank.

In another example, inSAR can be used to help detect small leaks from a storage container that would not otherwise be detectable by layover techniques, or even by visual observation, for example by detecting small changes in the tank volume persisting over several days or weeks.

The interferometric analysis may be applied to only two images, for example the first image collected in the first time window, and the first image collected in the second time window, in order to perform a more accurate phase comparison between the different time points, and to avoid losing phase information (as could be done when combining one or more images in the co-registration process described above in relation to operations 206 and 208).

In some embodiments, the step 506 of applying interferometric analysis to identify storage containers for which the quantity of stored fluid has changed may further comprise, before applying the interferometric analysis: determining a degree of coherence between the first and second image data; and verifying that the degree of coherence exceeds a predetermined coherence threshold. The interferometric analysis may then be applied only if the degree of coherence exceeds the coherence threshold. The degree of coherence threshold may, for example, be 0.5 or more, 0.6 or more, 0.7 or more, 0.8 or more, or 0.9 or more.

The coherence threshold may, for example, be a requirement that a baseline is shorter than a predetermined baseline threshold. The baseline threshold may in some examples, be 100 metres or more, 250 metres or more, 500 metres or more, 750 metres or more, or 1000 metres or more. In other examples the baseline threshold may in some examples 1000 metres or less, 750metres or less, 500 metres or less, 250 metres or less, or 100 metres or less. Alternatively, in some examples, the requirement may be that the baseline is within a predetermined baseline range. For example, the baseline range may be 100 metres to 250 metres, or 100 metres to 500 metres, or 100 metres to 750 metres, or 100 metres to 1000 metres; or 250 metres to 500 metres, or 250 metres or 750 metres, or 250 metres to 1000 metres; or 500 metres to 750 metres, or 500 metres to 1000 metres; or 750 metres to 1000 metres.

In the context of satellite based InSAR, the baseline for interferometric analysis is the distance between the location of the satellite that collected the first image data at the time when the first image data was collected and the location of the satellite that collected the second image data at the time when the second image data was collected. Generally, the shorter the baseline, the higher the degree of coherence between the first and second image data. Particularly, the perpendicular component of the baseline, i.e., the component of the baseline perpendicular to the line of sight of the first satellite, must satisfy the baseline threshold in most implementations. Coherence between the first and second image data is important because if the images lack coherence, then the results of interferometric analysis will not be reliable, or it may not even be possible to apply the interferometric analysis. With the baseline established and sufficient coherence, the interferometric analysis can be performed as in 506.

A further operation comprises quantifying the change in height of the lid 316 of the storage container 310 (and thereby quantifying the change in volume of fluid stored therein). This may be achieved in one of three ways, depending on the required resolution for quantifying the change. In a first example 508, where the SAR data provides for sufficient resolution, the so-called layover method may be implemented. In an example, in some imaging modes such as spot mode, lid height changes greater than approximately 50 cm can be detected. In another example using strip mode imagery, the detectable lid height change using layover is approximately 2.5 m or more. This layover method may constitute applying the method set out in relation to operations 206 to 214 to the received one or more sets of SAR image data that were collected by one or more satellites during the second period of time—i.e., the height(s) of the one or more storage containers that are determined to have experienced a change in the height of their lids 316 may be re-determined using the same method as used in operation 212. In other words, operation 508 may comprise determining the new height of the lid 316 based on the layover of the features 322, 324 in the second generated SAR image.

Additionally, or alternatively, if a better resolution is required than what can be achieved with layover techniques alone, InSAR techniques may be used to quantify or to help quantify the change in the height of the lid 316 in operation 510. Conventionally, InSAR is primarily used for change detection on large scales and not necessarily for quantifying those changes. However, if a suitable phase-unwrapping algorithm is applied, InSAR techniques can resolve changes in the phase that correspond to height changes on the order of the wavelength of the SAR imaging signal. In other words, InSAR can be used to quantify the change in the height of the lid with a high resolution, for example on the order of 20 centimetres to 100 centimetres.

In some examples, the step 510 of applying inSAR to quantify a change in height may comprise also using layover techniques in order to quantify the change in height. For example, even though inSAR techniques could be used to quantify changes in the order of centimetres, if the overall change is large enough (e.g., several meters) it may not be able to detect the full scale of difference. For example, the phase may indicate that the degree of difference is 5 cm, but you might not be able to know if the total change was 5 cm total or 505 cm total. In these cases, layover techniques can be used to first determine an approximate change in the height of the lid, for example to determine an approximate change 500 cm and then inSAR techniques can be used to refine the number and to make it more accurate. Using an analogy, layover techniques can be used to get the ball into the right part of the field, and then inSAR can be used to get the ball into the goal. The method of using layover as described with reference to FIGS. 2 and 3 could be used, or some other methods that also use the layover effect.

Additionally, or alternatively, if an even better resolution is required, for example to detect changes of less than a centimetre, differential InSAR techniques may be used to quantify the change in the height of the lid 316 with even higher resolution than is achievable with conventional InSAR techniques (in operation 512). Differential InSAR (also known as differential interferometry or shear interferometry) is based on determining the derivative of the phase change between images. In other words, beyond determining the phase change between images, differential InSAR also makes use of the rate of that phase change. By determining the rate of change of phase over time, it is possible to determine the first order correction in the phase change, thereby increasing the resolving power by a factor of 2 times to twenty times or more such that changes in the height of the lid can be resolved for example with a resolution of one centimetre to 10 centimetres. As in the case with inSAR, the step 512 of applying differential inSAR techniques to quantify a change in height can also comprise using layover techniques to help quantify the change in height. This could be the layover technique as described in FIGS. 2 and 3, or some other method using layover.

Traditionally inSAR has been used to detect changes in terrain, for example, imaging areas to look for ground slump or for changes in the shape of volcanoes. In these cases, the time frame for changes can be long and the changes can be quite small. For example, although when a volcano erupts it can do so quite quickly, there is usually a reasonable long period of time beforehand during which no change occurs. This allows time to establish a baseline.

It would not be obvious to use inSAR techniques for monitoring storage containers as described in this disclosure, or to combine inSAR techniques with layover techniques to detect changes and to quantify the changes in the height of the floating roof in a storage container, due to the size of the storage containers and the dynamic nature of the volume of fluid within storage containers

Establishing a baseline as described above requires at least two images imaged from similar viewing geometry during which the feature being imaged does not change. More images from the same viewing angle, for example 20 images, provides a better and more reliable baseline. Since the volume of fluid stored in the storage container changes regularly, it would traditionally not be possible to establish the same type of baseline that is used, for example, to monitor for land slump and for volcanoes. In those cases, baselines comprising multiple images can be collected over weeks or even months. As such, it would not be obvious to apply inSAR to monitoring of storage containers, which can be changing on a daily, if not hourly basis. Furthermore, traditional inSAR monitoring is applied for example to features such as volcanoes and areas subject to land slumps that are quite a bit larger in scale than the storage containers being monitored. InSAR was also not traditionally used in conjunction with layover techniques because the features being monitored (e.g., volcanoes and other landforms) did not lend themselves to analysis using layover.

Small high-resolution SAR satellites deployed in constellations as described in the current application have opened up the opportunity for unexpected and synergistic solutions for monitoring phenomenon such as storage containers through the use of layover techniques combined with inSAR, as described in this disclosure. Firstly, the high resolution achievable by the satellites in this description enable more accurate analysis using the layover technique that would not be possible using lower-resolution satellite imagery. Being able to use layover in these situations can lead to faster results once the decision or request has been made to monitor a particular storage container or group of storage containers because a baseline is not required. The more frequent revisits possible with a constellation of satellites also helps with establishing a baseline, making the use of inSAR possible even in a dynamic application such as oil tanks, which are changing regularly. With frequent revisits (e.g., daily) that are desired and required to monitor oil storage containers, it is more likely that a baseline can be established whereby the tank has not changed in between at least two imaging time periods. Even then, it is still not obvious to use the inSAR technique because in very active storage tank locations changes can occur hourly so establishing a baseline with at least two images in which the tank does not change could be difficult. This is where the combination of the layover technique combined with inSAR can yield significant unanticipated benefits. Since monitoring of the oil tanks using layover techniques does not require a baseline to be established, monitoring of the oil tanks can start immediately while a baseline is being established. Even with even very active storage locations, given enough time it should be possible to establish a baseline by obtaining at least two images where the storage tank hasn't changed. In essence, you can continue to take images until at least two images are taken in which the storage container has not changed, and a baseline can be established. Used in conjunction with layover techniques, having to establish a baseline and possibly taking quite awhile to establish a baseline is not a show stopper because monitoring is already going on, albeit not necessarily with the resolution that is possible with using inSAR techniques in combination with the layover techniques. Once the baseline has been established for inSAR, then change detection becomes easier and faster (the layover technique only needs to be applied to tanks have changed rather than all tanks), and the height results can increase in accuracy by using inSAR to help with quantifying the height of the lid in the storage container.

FIGS. 6a and 6b show an example of storage container 600, in this case an oil storage tank at an oil refinery, for which layover and inSAR analysis has been performed to monitor the amount of oil in the tank. The diameter of the tank is 125 m, determined either from imagery or from the manufacturer's specifications. Double-ended arrow 602 indicates the radar range direction, with arrow 604 indicating the near range (i.e., pointing towards the satellite) and arrow 606 indicating the far range (i.e., pointing away from the satellite).

Referring to FIG. 6a, bright ring 610 indicates the top of the tank, and the dark circle region 612 is the base of the tank. Bright spot 614 represents the nearest point (in the range direction) of the bottom edge 612 of the storage tank. Bright spot 614 corresponds to the bright spot 322(B) in FIG. 3. Bright spot 616 represents the top of the tank. Notice that due to its height point 616 appears closest to the satellite. This is because the distance the radar signal travels to a point on top of the tank and back to the satellite is less than the distance it travels to the corresponding point on the bottom of the tank and back to the satellite. Using the layover technique, the height of the tank can be determined, for example, to be 40 m. The lid of tank is indicated by ring 622, and bright spot 624 represents the “corner bounce” from the inside corner of the lid and the side of the tank in this first position. This corresponds to bright spot 324(L) in FIG. 3. Using the method described in FIGS. 2 and 3, the layover of the top of the tank can be measured to be 48 m and the layover of the lid can be measured to be 42 m, resulting in a layover ration of 42 m/48 m=0.875. The total volume of the tank is 490,873 m³ and multiplying this by 0.875 results in a current oil volume of 429,514 m³. The tank was monitored over three days from Dec. 1 to 3, 2021 and the images analysed using interferometry. The different shade in the results from analysis using inSAR and indicates a small, almost imperceptible change in the lid height. This small change could have resulted either from drawing down or refilling the tank, as described previously, a slight change in volume of the contents of the tank, or even from the expansion or contraction of the contents of the tank due to temperature. Regardless, there is no perceptible change in the layover of the lid and so using layover alone the tank would have been determined not to have changed between Dec. 1 and 3, 2021.

FIG. 6b is a composite image showing the same tank 600 from Dec 3 to 4, 2021, with the same radar direction represented by double-sided arrow 602 with the near range represented by arrow 604 and the far range represented by arrow 606. While the position of the tank itself is unchanged, there is a clear change in the position of the floating lid that has been highlighted by the inSAR analysis. The original position of the lid as shown in FIG. 6a is again shown in FIG. 6b by ring 622 with bright spot 620, but there is a change of phase as represented by the different shade of the ring and of the bring spot. The new position of the lid is now shown by bright ring 624 and bright spot 626 and has been highlighted in a different shade as well. Based on this change, which was highlighted by the inSAR analysis, layover can be applied to calculate the height of the lid. The new lid layover is 25 m, which translates to a layover ratio of 25 m/48 m=0.5208 and represents an oil volume of 255,663 m³. This represents a decrease in the oil volume in the tank of 235,210 m³. The tank was monitored with daily repeats of satellite imagery over the next few days, showing continuing activity in both drawing down and filling up the tank over that period of time.

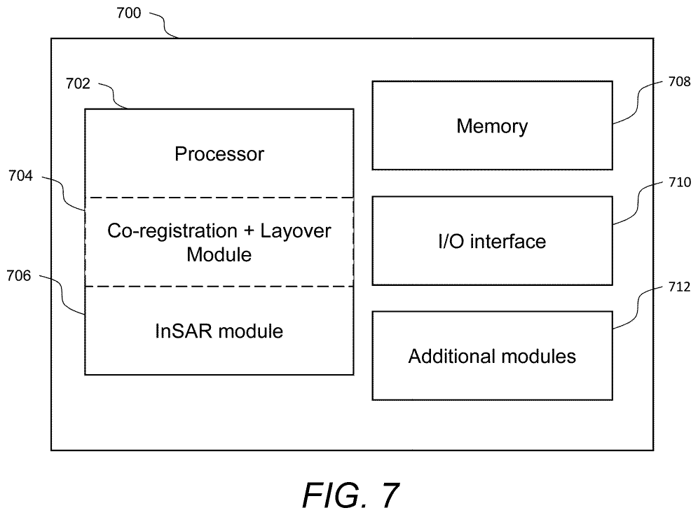

FIG. 7 shows a schematic of a computing system 700 comprising a processor 702 configured to implement the methods described herein. To facilitate this the processor 702 may comprise a dedicated co-registration and layover module 704 and/or a dedicated interferometry module 706. The computing system 700 further comprises a memory 708 configured to store, for example, the first and second sets of image data and results of the layover, InSAR, and/or differential InSAR analysis. The computing system 700 further comprises one or more communications interfaces, for example an I/O interface 710 for receiving and transmitting data. This may include receiving the first and second sets of image data and/or transmitting the results of the layover, InSAR, and/or differential InSAR analysis. The computing system 600 may further comprise additional modules 712 configured to carry out such operations as necessary for the functioning of the computing system 700 and the implementation of the methods described herein. The computing system may comprise a stand-alone computer of any kind known in the art or may comprise a distributed computing system. The computing system may be at one or more ground locations and may operate on data received from a satellite in orbit.

The embodiments described above may be fully automatic. In some examples a user or operator may manually instruct some steps of the method to be carried out.

In the described embodiments the computing system 600 may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and Blu-ray® disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fibre optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the claims.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A method of monitoring a stored volume of a fluid in a storage container having a lid resting on a surface of the fluid stored, the method comprising:
receiving a plurality of sets of image data collected by one or more satellites in orbit around Earth, wherein each set of image data corresponds to a respective synthetic aperture radar image of an area on Earth that includes the storage container;
grouping the plurality of sets of image data into one or more groups based on one or both of a direction of travel and/or a look direction of the respective satellite that collected the set of image data, and
for each of the one or more groups:
geometrically aligning at least two of the sets of image data within the group to define a stack of aligned image data;
identifying, in the stack of aligned image data a feature corresponding to a point on a bottom edge of the storage container;
geometrically aligning another set of image data from amongst the plurality of sets of image data with the stack of aligned image data;
identifying, in the another set of image data, a feature corresponding to a point on the lid;
and determining, based on the identified features, an estimate of a height of the lid relative to the bottom edge of the storage container.

2. The method according to claim 1, further comprising:
combining determined estimates of the height of the lid to obtain an overall determination of the height of the lid relative to the bottom edge of the storage container during a first period of time.

3. The method according to claim 1, further comprising:
receiving a further set of image data collected by a satellite in orbit around the Earth, wherein the further set of image data corresponds to a synthetic aperture radar image of an area that includes the storage container; and
applying interferometric analysis between a set of image data from the plurality of sets of image data and the further set of image data to determine if the height of the lid relative to the bottom edge of the storage container has changed between a first period of time and a second time.

4. The method according to claim 3, comprising: in response to determining that the height of the lid has changed:
identifying, in a two-dimensional image generated based on the received further set of image data, a feature corresponding to a point on the lid; and
determining, based on the identified feature, the height of the lid relative to the bottom edge of the storage container at the second time.

5. The method according to claim 3, further comprising: in response to determining that the height of the lid has changed:
receiving a plurality of further sets of image data collected by one or more satellites in orbit around the Earth, wherein each further set of image data corresponds to a respective synthetic aperture radar image of an area on Earth that includes the storage container;
grouping the plurality of further sets of image data into one or more groups based on one or both of the direction of travel and/or the look direction of the respective satellite that collected each set of image data; and
for each of the one or more groups:
geometrically aligning at least two of the sets of image data within the group to define a second stack of aligned image data;
identifying, in the second stack of aligned image data a feature corresponding to a point on the bottom edge of the storage container;
geometrically aligning a further set of image data from amongst the plurality of further sets of image data with the second stack of aligned image data;
identifying, in the further set of image data, a feature corresponding to a point on the lid, and
determining, based on the identified feature, a further estimate of the height of the lid relative to the bottom edge of the storage container.

6. The method according to claim 5, further comprising:
combining further determined estimates of the height of the lid to obtain an overall further determination of the height of the lid relative to the bottom edge of the storage container.

7. The method according to claim 1, wherein grouping the plurality of sets of image data comprises: assigning each of the plurality of images into a group wherein sets of image data collected by a satellite travelling in an ascending orbit are assigned to a different group to sets of image data collected by a satellite travelling in a descending orbit.

8. The method according to claim 1, wherein grouping the plurality of sets of image data comprises: assigning each of the plurality of images into a group wherein sets of image data collected by a satellite with a look angle oriented to a left of the direction of orbit of the satellite are assigned to a different group to sets of image data collected by a satellite with a look angle oriented to a right of the direction of orbit of the satellite.

9. The method according to claim 1, wherein determining the height of the lid relative to the bottom edge of the storage container comprises:
determining the a distance between the feature corresponding to the bottom edge of the storage container and the feature corresponding to the lid in a two-dimensional image; and
determining a height of the lid based on the determined distance and a look angle from which the satellite collects the corresponding image data.

10. The method according to claim 1, wherein the determined height of the lid is determined with a resolution of 2.5 m or better, 1 m or better, 0.5 m or better, 10 cm or better, or 1 cm or better.

11. The method according to claim 1, wherein the identified feature comprises one or more pixels in the image having a stronger signal than each of the pixels surrounding the one or more pixels.

12. The method according to claim 11, wherein the identified feature comprises a single pixel.

13. The method according to claim 3, wherein applying the interferometric analysis to determine if the height of the lid relative to the bottom edge of the storage container has changed between the first period of time and the second time comprises: determining an amount of change in the height of the lid based on the interferometric analysis.

14. The method according to claim 3, wherein applying the interferometric analysis comprises applying differential interferometric analysis to determine an amount of change in the height of the lid.

15. The method according to claim 3, the method further comprising: identifying, in each of the plurality of sets of image data, one or more storage containers in the respective area; and performing the identifying of the features and determining of the height of the corresponding lid for each of the identified storage containers.

16. The method according to claim 15, wherein applying the interferometric analysis comprises identifying for which of the one or more storage containers the height of the lid changed between collecting the plurality of sets of image data and the further set of image data.

17. A method of monitoring a stored volume of a fluid in a storage container having a lid resting on a surface of the fluid stored, the method comprising:
receiving a first set of image data collected by a satellite in orbit around Earth at a first time, wherein the first set of image data corresponds to a synthetic aperture radar image of an area on Earth that includes the storage container;
identifying, in a two-dimensional image corresponding to the first set of image data, a feature corresponding to a point on the lid,
determining, based on the identified feature, an estimate of a height of the lid relative to a bottom edge of the storage container at the first time; receiving a second set of image data collected by a satellite in orbit around the Earth at a second time, wherein the second set of image data corresponds to a synthetic aperture radar image of an area that includes the storage container; and
applying interferometric analysis between the first set of image data and the second set of image data to determine if the height of the lid relative to the bottom edge of the storage container has changed between the first time and the second time.

18. (canceled)

19. A computer storable medium comprising instructions that when executed by a computer cause the computer to:
receive a plurality of sets of image data collected by one or more satellites in orbit around Earth, wherein each set of image data corresponds to a respective synthetic aperture radar image of an area on Earth that includes the storage container;
group the plurality of sets of image data into one or more groups based on one or both of a direction of travel and/or a look direction of the respective satellite that collected the set of image data; and
for each of the one or more groups:
geometrically align at least two of the sets of image data within the group to define a stack of aligned image data;
identify, in the stack of aligned image data a feature corresponding to a point on a bottom edge of the storage container;
geometrically align another set of image data from amongst the plurality of sets of image data with the stack of aligned image data;
identify, in the another set of image data, a feature corresponding to a point on the lid;
and determine, based on the identified features, an estimate of a height of the lid relative to the bottom edge of the storage container.

20. (canceled)

21. The computer storable medium of claim 19 comprising instructions that when executed by a computer cause the computer further to:
receive a further set of image data collected by a satellite in orbit around the Earth, wherein the further set of image data corresponds to a synthetic aperture radar image of an area that includes the storage container; and
apply interferometric analysis between a set of image data from the plurality of sets of image data and the further set of image data to determine if the height of the lid relative to the bottom edge of the storage container has changed between a first period of time and a second time.

22. The computer storable medium of claim 21 comprising instructions that when executed by a computer cause the computer further to:
receive a plurality of sets of image data collected by one or more satellites in orbit around Earth, wherein each set of image data corresponds to a respective synthetic aperture radar image of an area on Earth that includes the storage container;
group the plurality of sets of image data into one or more groups based on one or both of a direction of travel and/or a look direction of the respective satellite that collected the set of image data; and
for each of the one or more groups:
geometrically align at least two of the sets of image data within the group to define a stack of aligned image data;
identify, in the stack of aligned image data a feature corresponding to a point on a bottom edge of the storage container;
geometrically align another set of image data from amongst the plurality of sets of image data with the stack of aligned image data;
identify, in the another set of image data, a feature corresponding to a point on the lid;
and determine, based on the identified features, an estimate of a height of the lid relative to the bottom edge of the storage container.
